(19) United States
(12) Patent Application Publication
(10) Pub. No.: US 2025/0045778 A1
(43) Pub. Date: Feb. 6, 2025

(54) GENERATIVE ARTIFICIAL INTELLIGENCE BASED SYSTEMS AND METHODS FOR MERGING NETWORKS OF HETEROGENEOUS DATA WHILE MAINTAINING DATA SECURITY

(71) Applicant: MASTERCARD INTERNATIONAL INCORPORATED, Purchase, NY (US)

(72) Inventor: Christopher John Merz, Wildwood, MO (US)

(21) Appl. No.: 18/920,645

(22) Filed: Oct. 18, 2024

Related U.S. Application Data
(63) Continuation-in-part of application No. 18/486,847, filed on Oct. 13, 2023.
Application No. 18/486,847 is a continuation of application No. 15/209,970, filed on Jul. 14, 2016, now abandoned.
(60) Provisional application No. 62/192,460, filed on Jul. 14, 2015.

(51) Int. Cl. G06Q 30/02; G06Q 30/0251; G06Q 30/0601

(52) U.S. Cl. CPC G06Q 30/02; G06Q 30/0255; G06Q 30/0631

(57) ABSTRACT

An artificial intelligence (AI)-based prediction recommender system is provided. The system includes a processor configured to generate a first matrix using a large language merchant transaction model including transaction data associated with a first plurality of users; generate a second matrix using a large language product transaction model including transaction data associated with a second plurality of users; generate a third matrix including transaction data associated with a third plurality of users; generate a preference vector associated with at least one accountholder wherein the preference vector representing historical purchases initiated by the accountholder with a second plurality of merchants; iteratively calculate a propagated activation vector by mathematically combining the first matrix, the second matrix, the third matrix and the preference vector; and output a recommendation associated with the at least one accountholder using the propagated activation vector.

### CROSS REFERENCE TO RELATED APPLICATIONS

This application is a continuation-in-part of and claims priority to U.S. application Ser. No. 18/486,847 filed on Oct. 13, 2023, which is a continuation of and claims priority to U.S. application Ser. No. 15/209,970 filed on Jul. 14, 2016, which claims priority to and the benefit of the filing date of U.S. Provisional Application No. 62/192,460 filed on Jul. 14, 2015, each of which are hereby incorporated by reference in their entirety.

### BACKGROUND

This disclosure relates generally to generative artificial intelligence (AI) and, more particularly, to generative AI operations used in combination with Large Language Models (LLMs) to merge heterogeneous data from computer networks to generate a predictive output while maintaining anonymity of data.

At least some known recommender systems use historical data to determine preferences of a user, which are then applied to new data to discern potential information in the new data that is of interest to the user. For example, by monitoring financial transaction data from financial transactions of a payment card cardholder, a pattern of cardholder preferences is able to be generated. For example, if a cardholder makes frequent purchases at outdoor oriented department stores and fewer purchases at bookstores, an inference may be made about the preferences of recreational activities favored by the cardholder. The recommender system would tend to provide other outdoor oriented stores to the cardholder when queried in for example, a new location.

Recurrent neural networks (RNNs) and/or generative artificial intelligence (AI) are closely related in the field of machine learning, and can be used to make recommendations from historical data. RNNs are a type of neural network architecture that may have a feedback loop in which the output of each neuron is fed back into the network as input. This feedback loop allows RNNs to process sequences of input data such as time series data or text data.

Generative AI refers to the use of machine learning algorithms to generate new, original content, such as images, music, or text. Generative AI may be used in applications such as creating realistic images, synthesizing speech, or generating novel text.

RNNs may be used in generative AI applications, particularly in natural language processing tasks such as language translation, speech recognition, and text generation. In these tasks, RNNs can be trained to predict the next word in a sequence of words, given the previous words as input. Once the RNN has been trained on a large dataset, it can be used to generate new text by sampling from the output distribution of the network.

Generative AI is a category that contains a myriad of tools built to use information from LLMs and other types of AI models using machine learning to generate new content, while an LLM is a type of AI model that uses machine learning built on billions of parameters to understand and produce text.

It is desirable to be able to predict what a person may do next and when they may do it. For example, it would be desirable to be able to accurately predict in an expeditious manner what product a person may purchase next (or within a predefined period of time) and where they may purchase it. The development of generative AI and LLM is helpful in being able to make such predictions. Accordingly, it is desirable to have a system that is configured to leverage generative AI and LLM operations to accurately and expeditiously predict and provide recommendations for alternate products or services, or sources of products or services to consumers or retailers, while conserving computer resources.

### BRIEF DESCRIPTION

In one embodiment, an artificial intelligence (AI)-based prediction recommender system is provided. The AI-based system includes at least one processor and at least one database in communication with the at least one processor. The at least one processor is configured to: (a) generate a first matrix using a large language merchant transaction model including transaction data associated with a first plurality of users, the first matrix correlating a first set of interactions among a first plurality of merchants; (b) generate a second matrix using a large language product transaction model including transaction data associated with a second plurality of users, the second matrix correlating a second set of interactions among a plurality of products; (c) generate a third matrix including transaction data associated with a third plurality of users, the third matrix correlating a third set of interactions between products and merchants where the products were purchased; (d) generate a preference vector associated with at least one accountholder, the preference vector representing historical purchases initiated by the accountholder with a second plurality of merchants; (e) iteratively calculate a propagated activation vector by mathematically combining the first matrix, the second matrix, the third matrix and the preference vector; and (f) output a recommendation associated with the at least one accountholder using the propagated activation vector, the recommendation including at least one of a merchant or a product predicted for purchasing by the accountholder.

In another embodiment, a computer-implemented method using an AI-based prediction recommender computing system including at least one processor and at least one database is provided. The method includes: (a) generating a first matrix using a large language merchant transaction model including transaction data associated with a first plurality of users, the first matrix correlating a first set of interactions among a first plurality of merchants; (b) generating a second matrix using a large language product transaction model including transaction data associated with a second plurality of users, the second matrix correlating a second set of interactions among a plurality of products; (c) generating a third matrix including transaction data associated with a third plurality of users, the third matrix correlating a third set of interactions between products and merchants where the products were purchased; (d) generating a preference vector associated with at least one accountholder, the preference vector representing historical purchases initiated by the accountholder with a second plurality of merchants; (e) iteratively calculating a propagated activation vector by mathematically combining the first matrix, the second matrix, the third matrix and the preference vector; and (f) outputting a recommendation associated with the at least one accountholder using the propagated activation vector, the recommendation including at least one of a merchant or a product predicted for purchasing by the accountholder.

In another embodiment, at least one non-transitory computer-readable storage medium having computer-executable instructions embodied thereon is provided. When executed by at least one processor of a AI-based prediction recommender system, the at least one processor in communication with at least one database, the computer-executable instructions cause the at least one processor to: (a) generate a first matrix using a large language merchant transaction model including transaction data associated with a first plurality of users, the first matrix correlating a first set of interactions among a first plurality of merchants; (b) generate a second matrix using a large language product transaction model including transaction data associated with a second plurality of users, the second matrix correlating a second set of interactions among a plurality of products; (c) generate a third matrix including transaction data associated with a third plurality of users, the third matrix correlating a third set of interactions between products and merchants where the products were purchased; (d) generate a preference vector associated with at least one accountholder, the preference vector representing historical purchases initiated by the accountholder with a second plurality of merchants; (e) iteratively calculate a propagated activation vector by mathematically combining the first matrix, the second matrix, the third matrix and the preference vector; and (f) output a recommendation associated with the at least one accountholder using the propagated activation vector, the recommendation including at least one of a merchant or a product predicted for purchasing by the accountholder.

In one embodiment, a prediction recommender system including at least one processor and at least one database is provided. The at least one processor is configured to generate, using one or more artificial intelligence (AI) techniques and transaction data associated with a first plurality of users, a first matrix within the at least one database, where the first matrix correlates a first set of interactions among a plurality of merchants. The at least one processor is also configured to generate, using the one or more AI techniques and item data associated with a second plurality of users, a second matrix within the at least one database, where the second matrix correlates a second set of interactions among a plurality of items associated with the item data. The at least one processor is further configured to combine, using a key common to the first matrix and the second matrix, the first matrix and the second matrix to generate a third matrix within the at least one database, where the third matrix includes a plurality of data cells, and where each of the plurality of data cells includes a value. The at least one processor is also configured to generate, using the one or more AI techniques and the third matrix, one or more results associated with at least one of one or more of the plurality of merchants or one or more of the plurality of items.

In another embodiment, a computer-implemented method using a prediction recommender system including at least one processor and at least one database is provided. The method includes generating, using one or more artificial intelligence (AI) techniques and transaction data associated with a first plurality of users, a first matrix within the at least one database, where the first matrix correlates a first set of interactions among a plurality of merchants. The method also includes generating, using the one or more AI techniques and item data associated with a second plurality of users, a second matrix within the at least one database, where the second matrix correlates a second set of interactions among a plurality of items associated with the item data. The method further includes combining, using a key common to the first matrix and the second matrix, the first matrix and the second matrix to generate a third matrix within the at least one database, where the third matrix includes a plurality of data cells, and where each of the plurality of data cells includes a value. The method also includes generating, using the one or more AI techniques and the third matrix, one or more results associated with at least one of one or more of the plurality of merchants or one or more of the plurality of items

In yet another embodiment, at least one non-transitory computer-readable storage media has computer-executable instructions embodied thereon is provided. When executed by at least one processor, the computer-executable instructions cause the at least one processor to generate, using one or more artificial intelligence (AI) techniques and transaction data associated with a first plurality of users, a first matrix within the at least one database, where the first matrix correlates a first set of interactions among a plurality of merchants. The computer-executable instructions also cause the at least one processor to generate, using the one or more AI techniques and item data associated with a second plurality of users, a second matrix within the at least one database, where the second matrix correlates a second set of interactions among a plurality of items associated with the item data. The computer-executable instructions further cause the at least one processor to combine, using a key common to the first matrix and the second matrix, the first matrix and the second matrix to generate a third matrix within the at least one database, where the third matrix includes a plurality of data cells, and where each of the plurality of data cells includes a value. The computer-executable instructions also cause the at least one processor to generate, using the one or more AI techniques and the third matrix, one or more results associated with at least one of one or more of the plurality of merchants or one or more of the plurality of item.

### BRIEF DESCRIPTION OF THE DRAWINGS

FIGS. 1-11 show example embodiments of the methods and systems described herein.

FIG. 1 is a schematic diagram illustrating an example multi-party payment card network system having an AI-based prediction recommender system.

FIG. 2 is a simplified block diagram of the payment card network system including a plurality of computer devices including the AI-based prediction recommender system.

FIG. 3A is an expanded block diagram of an example embodiment of an architecture of a server system of the payment card network system shown in FIGS. 1 and 2.

FIG. 3B shows a configuration of the database shown in FIG. 1 within the database server of the server system also shown in FIG. 1 with other related server components.

FIG. 4 illustrates an example configuration of a user system operated by a user, such as the cardholder shown in FIG. 1.

FIG. 5 illustrates an example configuration of a server system such as the server system shown in FIGS. 2 and 3A.

FIG. 6 is flow chart of an example method of merging heterogeneous data types that may be used with the AI-based prediction recommender system shown in FIG. 1.

FIG. 7 is a diagram of a correspondence matrix generated by the prediction recommender system shown in FIG. 1 in an example embodiment of the present disclosure.

FIG. 8 is a schematic block diagram of the AI-based prediction recommender system shown in FIG. 1 in accordance with an example embodiment of the present disclosure.

FIG. 9 is a data flow diagram of prediction recommender system in accordance with an example embodiment of the present disclosure.

FIG. 10 is a schematic diagram showing generative artificial intelligence (AI) operations that include a recurrent neural network (RNN) feedback loop and large language models (LLMs) to generate a first predictive output using the prediction recommender system shown in FIG. 1.

FIG. 11 is a schematic diagram showing generative AI operations that include an RNN feedback loop and LLMs to generate a second predictive output using the prediction recommender system shown in FIG. 1.

### DETAILED DESCRIPTION

Embodiments of the AI-based prediction recommender system described herein enable a merchant to upload and merge product-level (e.g., SKU, hotel property, etc.) data associated with payment card transaction data, without divulging the product details, to enable personalization of recommendations for customers of the merchant. The AI-based prediction recommender system determines a cardholder's purchasing behavior using the cardholder's own financial transaction data and financial transaction data from other cardholders to predict other merchants or products the cardholder would be interested in patronizing or purchasing. This is useful when the cardholder travels to new locations and is unfamiliar with the merchants in the location traveled to. In addition, other cardholders' experiences may also be captured in the matrix generated from the financial transaction data of the other cardholders. The behavior of the cardholder and the other cardholders influence the results of the prediction recommender system, such that the prediction recommender system can predict merchants likely to satisfy the cardholder's requirements.

Moreover, with additional information, the prediction can be extended to product recommendations a well. In various embodiments, the process is compliant with data usage guidelines for both opt-in and non-opt-in cardholder scenarios. As used herein, data usage guidelines refer to rules committed to avoid use of data that is personally identifiable either directly or indirectly and that may include different levels of privacy for different levels of permissions. For example, a cardholder or merchant that wishes for more accurate predicted recommendation results may opt-in to different levels of approval for use of their data. In other cases, the merchant or cardholder is able to keep the personal data anonymous and the system is still able to generate predictions that can be provided to the merchant or cardholder and used to make further predictions. Thus, the system is able to work on anonymous data as well as identified data.

In one embodiment, payment card transaction data is received from, for example, a payment card network server and organized into a data structure, such as, but not limited to a two-dimensional (2D) matrix having merchant locations across each axis. Payment card transactions for many different cardholders related to each pair of merchants making up a cell of the matrix are tallied in a matrix calculator, such that, a degree of interaction between the two merchant locations can be determined. As used herein, tallying may refer to simple incrementing or decrementing the contents of a matrix cell, or may refer to more complex determinations of the contents of a cell of the matrix, such as, but not limited to polynomial expressions, and the like. Also, as used herein, a degree of interaction relates to the use of a payment card at each of the two merchants or other contact with either of the two merchants. For example, signing up to a merchant's email list, providing a review of the merchant's product or service, or the like is a form of interaction that may be tallied to determine a degree of interaction relating to merchants or products. The use of the payment card at each merchant is another form of interaction that is tallied in the cell of the 2D matrix associated with the two merchants or two products. A greater tally in the associated cell indicates a greater interaction. Additionally, the degree of interaction may be lessened by certain activities. For example, a negative experience at a merchant could decrement a tally associated with a merchant. In one embodiment, the results of forming the matrix may be displayed in a node and edge graph where nodes are merchant locations and edges connect the merchant locations that are related by a number of interactions. The number of interactions between merchant locations is displayed as different size connections, for example, a thicker arrow connecting related merchant locations may represent more interactions than merchant locations having only a few interactions. Similarly, color may be used to indicate the degree of connectivity between related merchant locations.

Using the matrix, a merchant location the customer is likely to patronize may be determined based on a customer's patronizing of another location of a merchant.

Similarly, product data from the merchant locations can be organized in a second matrix generator into a second matrix using product level data from the merchants. For example, the product level data is used to tally interactions between products. The tallied interactions could indicate that a customer purchasing a tent is also likely to purchase other camping equipment based on a significant number of interactions between tent product data and for example, camp stove product data. Based on the tally of interactions between each product data cell in the second matrix to each other product data cell in the second matrix, a recommender system, using the second matrix, can determine which pairings of product data are most likely to show which products will be purchased with each other product.

Further, the first and second matrices are combined in a matrix calculator with a third matrix using a key common to each of the first and second matrix, such as, but not limited to, one or more elements of financial transaction data relating to each interaction to provide further recommendations. A recommender system based on the third matrix is used to show recommendations beyond only other products purchased as is shown using the second matrix or only other merchant locations where purchases were made as is shown using the first matrix. A recommender system based on the third matrix can determine a ranking of interactions not only between merchant locations and between product data, but between product data at different merchant locations as well. For example, using the third matrix, a ranking of recommended products can be for more than one store. Using the example above, a purchase of a tent at one merchant location may be shown to be more closely related to a purchase of a camp stove at a different location than a purchase of a camp stove at the same merchant location. Such a ranking of recommended products is useful for a merchant to display if the different merchant location is a partner merchant. In contrast to the multi-party payment card system, in a closed loop private label payment card system, issuers are directly connected to their partner merchants to process private label transactions using a proprietary network. In the private label payment card system, the private label transactions received by issuers must originate at the known locations of participating partner merchants. For example, an authorization request must be initiated from a partner merchant because partner merchants are the only merchants permitted to be connected to private label network. Issuers transmit authorization responses to merchants using the private label network.

As explained below in further detail, the first matrix is a merchant by merchant correspondence matrix for a large group of cardholders. The second matrix is a product by product correspondence matrix for the same or a portion of the large group of cardholders. The third matrix is sample data that is collected showing a relationship between a merchant and product for the group of cardholders. In some cases, the sample data of the third matrix is known data that is collected from an opt-in process or a co-branded card where the purchase data may be collected and includes items purchased from known merchants. In other cases, the sample data used within the third matrix is generated in a probabilistic manner where certain limited and anonymous data is provided to the system, and the system is configured to generate relationships, based on probabilities, between products purchased and merchants. In some cases, this data may include connections between a purchase amount and a merchant or a product identifier.

Once the three matrices are generated, transaction information may be added by updating in near real-time at least one of individual cells, individual columns, and individual rows of the third matrix based on transactions occurring within a predetermined time. As used herein, real-time refers to updating at least one of individual cells, individual columns, and individual rows of the third matrix within a substantially short period after receiving new financial transaction data, for example, receiving financial transaction data and updating individual cells, individual columns, and/or individual rows of the first and/or second matrix. Real-time or near real-time does refers to updates occurring without substantial intentional delay.

In addition, the prediction recommender system may generate and update each matrix using generative artificial intelligence (AI) operations including at least one large language model (LLM) such as a Large Language Merchant Transaction Model (LLMTM). For example, the prediction recommender system may use the at least one LLMTM to generate a first matrix (e.g., Merchant by Merchant (M×M) matrix) including a plurality of rows and columns, where the intersection of each row and column forms a cell. Each row represents a merchant location ordered in a predetermined order and each column also represents a merchant location in the same order or a different predetermined order. Each cell represents a number of interactions between each merchant location that intersects at that cell. An interaction typically represents a transaction by a cardholder that takes place at both merchant locations that make up the intersection. The LLMTM may include transaction data (in some cases anonymous transaction data) showing a relationship between merchants so that the matrix can be generated showing where one cardholder purchases or interacted with two merchants.

The prediction recommender system may also use the at least one LLM to generate the second matrix (e.g., Product by Product (P×P) matrix) including a plurality of rows and columns, where the intersection of each forms a cell. Each row represents product data of a selectable merchant location ordered in a predetermined order and each column also represents product data of a selectable merchant location in the same order or a different predetermined order. Each cell represents a number of interactions between each product data that intersects at that cell. In this case, an interaction typically represents two products that are purchased at a merchant location. A value in each cell indicates a tally of the instances when the products represented by the row and column are purchased together.

The prediction recommender system may further generate the third matrix (e.g., Merchant by Product (M×P) matrix or Product by Merchant (P×M) matrix) by linking the first and second matrices using at least one of an exact key, an overlapping key, and/or a non-overlapping key. The steps taken by the prediction recommender system to create the third matrix are described in more detail below.

By using the LLMTM to generate the matrices, the prediction recommender system converts text included in each matrix into numerical vectors. In other words, the rows, columns, and cells in each matrix include data (e.g., merchant, product, etc.) in the form of numerical vectors. This conversion offers several advantages, such as: (i) a machine learning compatibility: numerical vectors are essential for applying machine learning algorithms to text data, and most machine learning models require numerical input, and vectorization enables this transformation; (ii) a semantic representation: by using techniques like word embeddings or contextual embeddings, the numerical vectors can capture semantic meaning, thereby enabling the model to understand relationships between words and concepts in the text; (iii) a dimensionality reduction: vectorization can reduce the dimensionality of the data, making it more manageable for analysis while retaining essential information; (iv) efficient processing: once text is represented numerically, it becomes easier to process and analyze at scale, which is especially important when dealing with large volumes of textual data; (v) similarity measurement: numerical vectors streamline computation of similarities between texts, which is useful for tasks like recommendation systems, information retrieval, and clustering; and (vi) interdisciplinary integration: numerical vectors enable integration between natural language processing and other fields, such as computer vision or numerical analysis, enabling for interdisciplinary applications. In general, converting text into numerical vectors is a fundamental step for the systems and methods described herein in enabling the application of various machine learning and statistical techniques to provide a wide range of analysis and insights.

Once the three matrices are created from a large set of cardholders, the prediction recommender system is configured to combine the three matrices with a preference vector (which may include a product portion of the preference vector and/or a merchant portion of the preference vector) to generate a predictive model (also referred to as a predictive vector model or a propagated activation vector) that may output predictions in the form of recommendations either recommending a merchant for a cardholder based upon a product input or recommending a product for a cardholder based upon a merchant input. The preference vector may include numerical vectors representing a plurality of primary account numbers (PANs) and/or one or more products that an interested party (e.g., a merchant) might want to sell, such that the predictive model may output predictions associated with the data represented by the numerical vectors. In addition, the prediction recommender system may use the predictive model to feedback into the LLMs as a recurrent neural network (RNN), such that input data may be processed sequentially while maintaining the internal state of the input data when passing the input data along to the next step. By doing so, the LLMs used by the prediction recommender system are refined and/or re-trained, thereby improving accuracy of the output predictions.

In other words, the merchant to merchant LLMTM matrix (first matrix), the product to product LLM matrix (second matrix), and the product to merchant LLM matrix (third matrix) are combined with the preference vector for a selected cardholder or set of cardholders to output the propagated activation vector for predicting future purchases (of products or services) of those cardholders at certain merchants. In some cases, the preference vector may include merchant data representing the merchants that the selected cardholders shopped at, and/or product data representing the products purchased by the selected cardholders and/or a combination of both. The preference vector, which is actual historical purchase data of the selected cardholder or cardholders, is applied to the three matrices (historical data of a large set of cardholders) to output the prediction model or propagated activation vector. In some cases, the propagated activation vector can be re-applied to the preference vector by adjusting the weights of the preference vector so that additional activation can be generated and included within the second or third round of generating the propagated activation vector. The propagated activation vector includes a prediction as to where the selected cardholder will shop (which merchants) and what products they are likely to buy soon. As explained below, this can all be generated while maintaining data anonymity if that is so desired.

In one example, the prediction recommender system may apply a cardholder vector of past purchases (e.g., a preference vector) to the numerical vectors in the three matrices to output specific recommendations for that cardholder related to, for example, a personalized offer. In another example, the prediction recommender system may apply a product preference vector (for a set of cardholders) to the numerical vectors in the three matrices to output (i) a recommended product endcap at a merchant store, (ii) a recommended new menu for a restaurant, (iii) a recommended product to display on a webpage for potential purchasers, (iv) a recommended loyalty catalog for potential purchasers, (v) a product related recommendation, (vi) a merchant related recommendation, or (vii) any other type of product or merchant recommendation that may be requested by a requestor.

Additionally, or alternatively, the prediction recommender system may use generative AI, LLMs, LLMTMs, RNNs, matrices, preference vectors, and/or predictive models to generate and provide outputs without sharing, or exposing personal identifiable information (PII) of cardholders, merchants, or any requestor of outputs from the prediction recommender system. The system may generate and provide such outputs by (i) generating the first matrix (e.g., M×M matrix) using at least one LLMTM, (ii) generating the second matric (e.g., P×P matrix) using the at least one LLM, (iii) linking the first matrix to the second matrix to generate at least one third matrix (e.g., M×P matrix and/or P×M matrix) having numerical vectors generated using the at least one LLM, and (iv) applying preferred vector data to the at least one third matrix and using generative AI operations to output at least one predictive model including at least one predictive result. The system and method described herein is configured to provide these different predictions while maintaining the confidential nature of any such data.

As used herein, the terms “transaction card,” “financial transaction card,” and “payment card” refer to any suitable transaction card or value transfer device, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, New York). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The following detailed description illustrates embodiments of the disclosure by way of example and not by way of limitation. It is contemplated that the disclosure has general application to processing financial transaction data in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

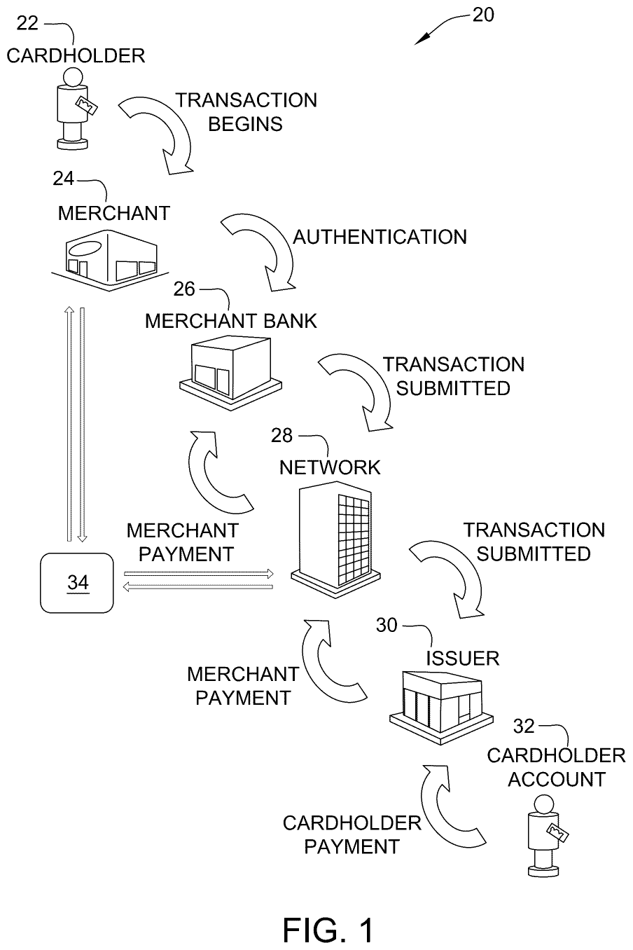

FIG. 1 is a schematic diagram illustrating an example multi-party payment card network system 100 communicatively coupled to an AI-based prediction recommender system 34. Multi-party payment card network system 100 enables payment card transactions between merchants and cardholders. The prediction recommender system 34 is a system that enables merchant data captured by the multi-party payment card network system to be combined with product level data from at least some of the merchant locations using the matrix data structure described herein. The AI-based predictive system, using Generative AI, LLMs, LLMTMs, and/or RNNs, combines the data to output a customized product recommendation or other merchant recommendation during a web browsing session to cardholders and/or customers based on products and/or merchant locations viewed and/or purchased from by the cardholders and/or customers. This can be done during a web browsing session or it can be pushed to a person's mobile device based on the person's interaction with the device or based on the GPS location of the person with the device.

Embodiments described herein may relate to a financial transaction card system, such as a payment card network operated by Mastercard International Incorporated®. The payment card network, as described herein, is a four-party payment card network that includes a plurality of special purpose processors and data structures stored in one or more memory devices communicatively coupled to the processors, and a set of proprietary communications standards promulgated by Mastercard International Incorporated® for the exchange of financial transaction data and the settlement of funds between financial institutions that are members of the payment card network. As used herein, financial transaction data includes a unique account number associated with a cardholder using a payment card issued by an issuer, purchase data representing a purchase made by the cardholder including a type of merchant, amount of purchase, date of purchase, and other data, which may be transmitted between any parties of multi-party payment card network system 20.

In the example embodiment, the prediction recommender system 34 includes one or more special purpose processors and data structures stored in one or more memory devices communicatively coupled to the processors. The prediction recommender system 34 may also be in communication with certain AI tools including tools that allow the prediction recommender system 34 to perform Generative AI operations, LLM operations and/or RNN operations. The prediction recommender system 34 also includes the ability to interface with the set of proprietary communications standards promulgated by Mastercard International Incorporated® for the exchange of financial transaction data. The one or more special purpose processors and data structures associated with prediction recommender system 34 may include some of the one or more special purpose processors and data structures of the one or more special purpose processors and data structures associated with Mastercard International Incorporated®. In such an embodiment, prediction recommender system 34 operates using the resources of prediction recommender system 34. Alternatively, prediction recommender system 34 may also be a stand-alone or third party system communicatively coupled or assessable to payment card network system 100 where the one or more special purpose processors and data structures associated with prediction recommender system 34 may only communicate with the one or more special purpose processors and data structures of the one or more special purpose processors and data structures associated with Mastercard International Incorporated®.

In a typical payment card system, a financial institution called the “issuer” issues a payment card, such as a credit card, to a consumer or cardholder 22, who uses the payment card to tender payment for a purchase from a merchant 24. To accept payment with the payment card, merchant 24 must normally establish an account with a financial institution that is part of the payment card network system. This financial institution is usually called the “merchant bank,” the “acquiring bank,” or the “acquirer.” When cardholder 22 tenders payment for a purchase with a payment card, merchant 24 requests authorization from a merchant bank 26 for the amount of the purchase. The request may be performed over the telephone, but is usually performed through the use of a point-of-sale terminal or an online webpage or computer app, which reads or otherwise receives cardholder's 22 account information from a magnetic stripe, a chip, or embossed characters on the payment card which may be inputted by a user and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a payment card network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

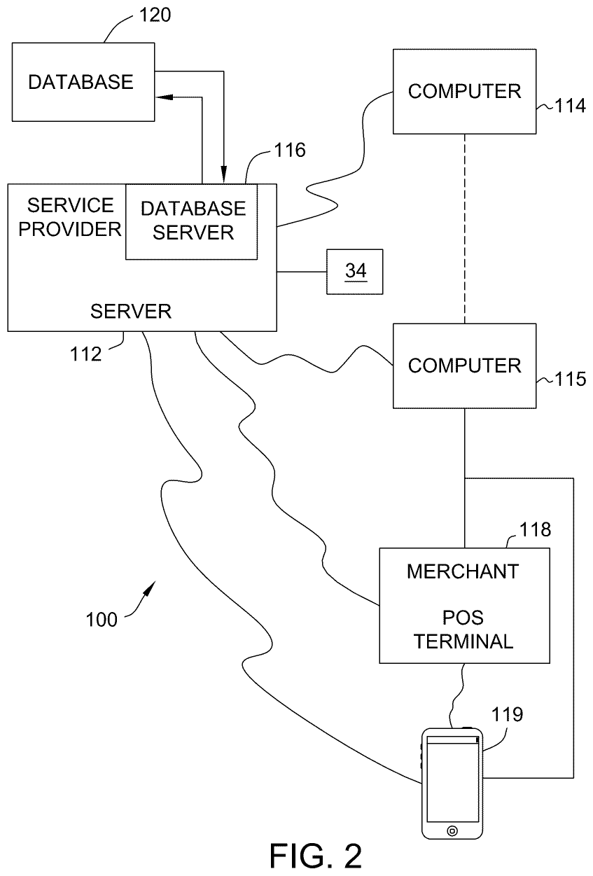

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal or via the website or computer app. This may include bundling of approved transactions daily for standard retail purchases. If cardholder 22 cancels a transaction before it is captured, a “void” is generated. If cardholder 22 returns goods after the transaction has been captured, a “credit” is generated. Payment card network 28 and/or issuer bank 30 stores the financial transaction data, such as a type of merchant, amount of purchase, date of purchase, in a database 120 (shown in FIG. 2).

For debit card transactions, when a request for a PIN authorization is approved by the issuer, the consumer's account is decreased. Normally, a charge is posted immediately to a consumer's account. The issuer 30 then transmits the approval to the merchant bank 26 via the payment network 28, with ultimately the merchant 24 being notified for distribution of goods/services, or information or cash in the case of an ATM.

After a purchase has been made, a clearing process occurs to transfer additional transaction data related to the purchase among the parties to the transaction, such as merchant bank 26, payment card network 28, and issuer bank 30. More specifically, during and/or after the clearing process, additional data, such as a time of purchase, a merchant name, a type of merchant, purchase information, cardholder account information, a type of transaction, product or service for sale information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment card network 28, and then between payment card network 28 and merchant bank 26, and then between merchant bank 26 and merchant 24.

Network 28 is configured to interface with AI-based prediction recommender system 34. Prediction recommender system 34 is configured to receive financial transaction data from payment card network 28 for a set of cardholders to generate a first matrix of merchants (M×M) and/or merchant locations. The captured and stored merchant data may be considered a merchant transaction GPT or Large Language Merchant Transaction Model that may be executed to form the first matrix. A tally of interactions between the merchants is used to populate the first matrix. Prediction recommender system 34 is also configured to receive product data from one or more of merchants 24 to generate a second matrix of product data (P×P). The captured and stored product data may be considered a product transaction GPT or Large Language Product Transaction Model that may be executed to form the second matrix. A tally of interactions between the different product data is used to populate the second matrix. The AI-based prediction recommender system 34 is further configured to generate a third matrix that combines known or determined product to merchant (P×M) data that is then mathematically combined with the first matrix and the second matrix. The third matrix is used to help build relationships between merchants and products. This multiple matrix data structure is then mathematically combined with a preference vector that includes recent purchase data for a selected cardholder or set of cardholders to iteratively generate a propagated activation vector or model that outputs a targeted and custom recommendation for the selected cardholder or set of cardholders of a product or merchant that the cardholder will likely interact with. This output may then be provided to the cardholder(s) through a website, an app on a mobile device, a kiosk, or pushed to the cardholder.

FIG. 2 is a simplified block diagram of payment card network system 100 including a plurality of computer devices including the AI-based prediction recommender system 34. In the example embodiment, the plurality of computer devices includes, for example, server system 112, client systems 114, 115, and prediction recommender system 34. In one embodiment, payment card network system 100 implements a process to generate recommendations of merchant locations, products sold at each merchant locations, and/or combinations thereof. More specifically, the AI-based prediction recommender system 34 is in communication with server system 112 and is configured to receive at least a portion of the transaction data relating to purchase transactions (or other interactions) between a plurality of merchants and cardholders. The transaction data includes information about the location of the merchant, products purchased, transaction amounts, dates and times of the transactions, etc. This data may in some case be enriched with personal data or may be anonymized in some way. The system is able to generate recommendations whether the data is enriched or anonymized. The received data is stored in a memory device.

More specifically, in the example embodiment, payment card network system 100 includes a server system 112, and a plurality of client sub-systems, also referred to as client systems 114, 115, connected to server system 112. In one embodiment, client systems 114, 115 are computers including a web browser, such that server system 112 is accessible to client systems 114, 115 using the Internet. Client systems 114, 115 are interconnected to the Internet through many interfaces including a network, such as a local area network (LAN) or a wide area network (WAN), dial-in-connections, cable modems, and special high-speed Integrated Services Digital Network (ISDN) lines. Client systems 114, 115 could be any device capable of interconnecting to the Internet including a web-based phone, PDA, or other web-based connectable equipment.

Payment card network system 100 also includes point-of-sale (POS) terminals 118, which may be connected to client systems 114, 115 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device 119 capable of reading information from a consumer's financial transaction card. Input device 119 may also be in communication with server system 112 and client systems 114, 115. Input device 119 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on server system 112 and can be accessed by potential users at one of client systems 114, 115 by logging onto server system 112 through one of client systems 114, 115. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, a primary account number (PAN) associated with the cardholder name, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store picture files associated with the item or service for sale by the merchant user, name, price, description, shipping and delivery information, instructions for facilitating the transaction, and other information to facilitate processing according to the method described in the present disclosure.

In the example embodiment, one of client systems 114, 115 may be associated with acquirer bank 26 (shown in FIG. 1) while another one of client systems 114, 115 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with payment card network 28 (shown in FIG. 1). In the example embodiment, server system 112 is associated with a financial transaction processing network, such as payment card network 28, and may be referred to as an interchange computer system. Server system 112 may be used for processing transaction data. In addition, client systems 114, 115 and/or POS terminal 118 may include a computer system associated with at least one of an online bank, a bill payment outsourcer, an acquirer bank, an acquirer processor, an issuer bank associated with a transaction card, an issuer processor, a remote payment processing system, a biller, and/or a prediction recommender system 34. The AI-based prediction recommender system 34 may be associated with payment card network 28 or with an outside third party in a contractual relationship with payment card network 28. Accordingly, each party involved in processing transaction data are associated with a computer system shown in payment card network system 100 such that the parties can communicate with one another as described herein.

Using payment card network 28, the computers of the merchant bank or the merchant processor communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as Mastercard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

As described above, AI-based prediction recommender system 34 is configured to receive transaction data from payment card server 112 and generate a first matrix of merchants (M×M) and/or merchant locations. The received and stored merchant data may be considered a merchant transaction GPT or Large Language Merchant Transaction Model that may be executed to form the first matrix. The LLMTM model of merchant data may include a variety of data that needs to be organized into a vector for further analysis in the first matrix. Prediction recommender system 34 is also configured to receive product data from one or more of merchant devices 118 to generate a second matrix of product data (P×P). The received and stored product data may be considered a product transaction GPT or Large Language Product Transaction Model that may be executed to form the second matrix. The LLPTM model of product data may include a variety of data that needs to be organized into a vector for further analysis in the second matrix. This can be done using RNN and/or ChatGPT tools. The AI-based prediction recommender system 34 is further configured to generate a third matrix that combines known (data gathered as a result of a co-brand card being used) or determined (probabilistic determination from limited or anonymous data) product to merchant (P×M) data that is then mathematically combined with the first matrix and the second matrix. The third matrix is used to help build relationships between merchants and products. This multiple matrix data structure is then mathematically combined with a preference vector that includes recent purchase data for a selected cardholder or set of cardholders. The preference vector includes a merchant portion and a product portion. In some cases, the system may have both portions. But typically, the system may only have one portion or the other, or a partial portion of each. The preference vector is combined with the matrices to iteratively generate a propagated activation vector or model that outputs a targeted and customized recommendation for the selected cardholder or set of cardholders of a product or merchant that the cardholder(s) will likely interact with and/or purchase from. This output may then be provided to the cardholder(s) through a website, an app on a mobile device, a kiosk, or pushed to the cardholder.

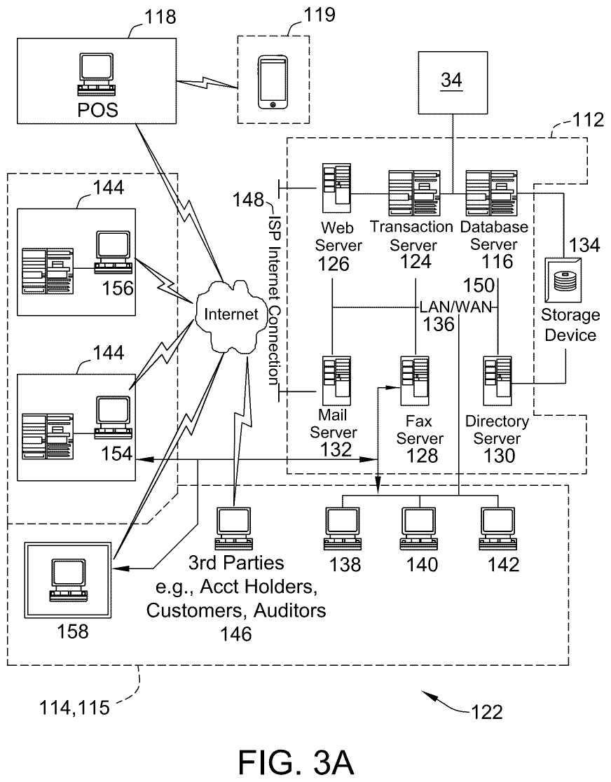

FIG. 3A is an expanded block diagram of an example embodiment of an architecture of a server system 122 of payment card network system 100. Components in system 122 are identical to components of payment card network system 100, which are identified in FIG. 3A using the same reference numerals as used in FIG. 2. For example, prediction recommender system 34 is similarly labeled in FIGS. 1, 2, and 3A. System 122 includes server system 112, client systems 114, 115, POS terminals 118, and at least one input device 119. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to prediction recommender system 34 and various computer devices, such as workstations 138, 140, 142, and 144 associated with individuals, including employees and workstation 146 associated with third parties, e.g., account holders, customers, auditors, developers, consumers, merchants, acquirers, issuers, etc., using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, LAN 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 158 using a telephone link. Fax server 128 is configured to communicate with workstations 138, 140, and 142 as well.

FIG. 3B shows a configuration of database 120 within database server 116 of server system 112 with other related server components. More specifically, FIG. 3B shows a configuration of database 120 in communication with database server 116 of server system 112 also shown in FIGS. 2 and 3A. Database 120 is coupled to several separate components within server system 112, which perform specific tasks.

Server system 112 includes a receiving component 160 for receiving a first corpus of first data, the first data includes an indicator of an interaction between a first element of the first corpus of first data and a second element of the first corpus of first data, a generating component 162 for generating a first matrix that correlates the interactions between the first element and the second element, a receiving component 164 for receiving a second corpus of second data, the second data includes an indication of an interaction between a third element of the second corpus of second data and a fourth element of the second corpus of data, a generating component 166 for generating a second matrix that correlates the interactions between the third element and the fourth element, a generating component 168 for generating a third matrix by merging the first matrix and the second matrix using a key defined by the interactions between the first and second elements and the interactions between the third and fourth elements.

In an example embodiment, payment card network system 100 includes an administrative component (not shown) that provides an input component as well as an edit component to facilitate administrative functions. Payment card network system 100 (shown in FIG. 2) is flexible to provide other alternative types of reports and is not constrained to the options set forth above.

In an example embodiment, database 120 is divided into a plurality of sections, including but not limited to, a Transaction and Purchase Data Section 170, a Merchant Data Section 172, and a Cardholder Account Data Section 174. These sections within database 120 are interconnected to update and retrieve the information as required.

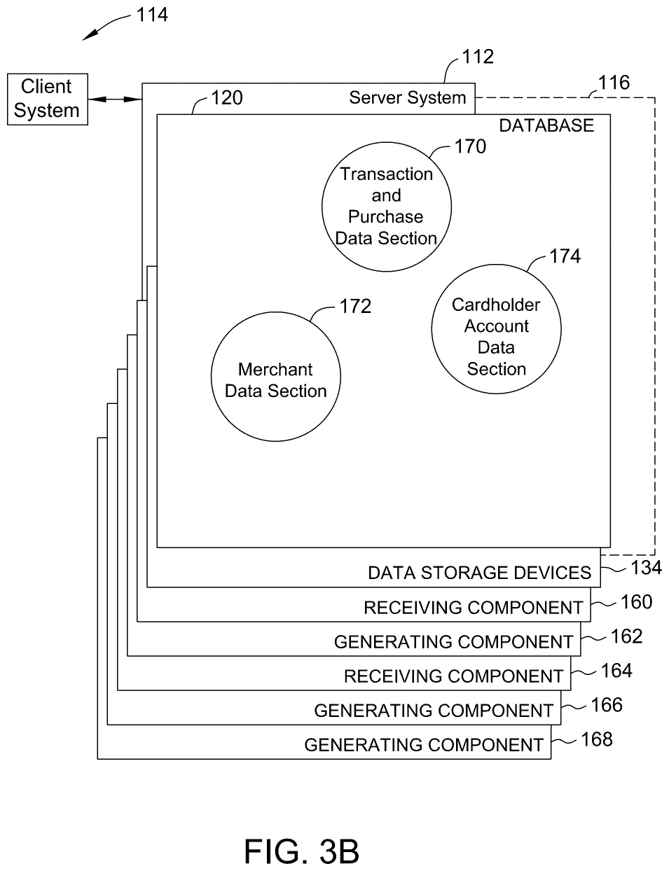

FIG. 4 illustrates an example configuration of a user system 202 and operated by a user 201, such as cardholder 22 (shown in FIG. 1). User system 202 may include, but is not limited to, client systems 114, 115, workstations 138, 140, 142, 144, 146, POS terminal 118, and input device, 119 (all shown in FIG. 3A). In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or other data to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112 (shown in FIG. 2). Communication interface 225 may include, for example, a wired or wireless network adapter or a wireless data transceiver for use with a mobile phone network, Global System for Mobile communications (GSM), 3G, 4G or Bluetooth or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

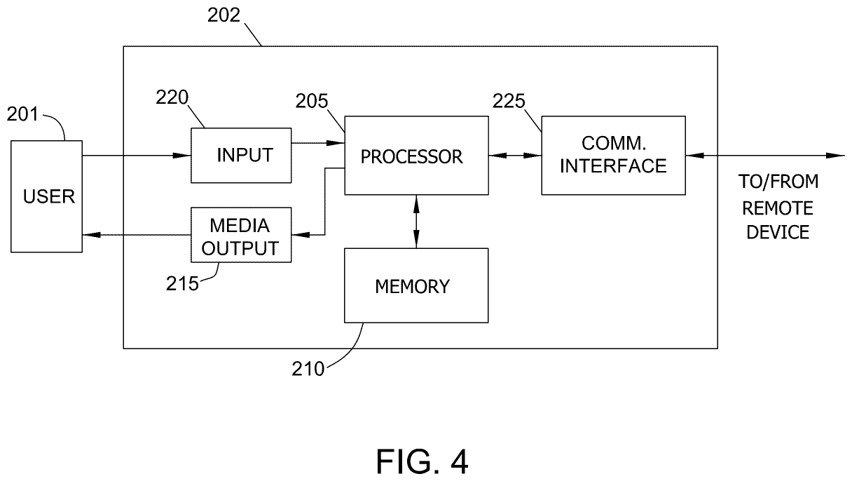

FIG. 5 illustrates an example configuration of a server system 301 such as server system 112 (shown in FIGS. 2, 3A, and 3B). Server system 301 may include, but is not limited to, database server 116, transaction server 124, web server 126, fax server 128, directory server 130, and mail server 132 (all shown in FIG. 3A).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 305 is operatively coupled to a communication interface 315 such that server system 301 is capable of communicating with a remote device such as a user system 202 (shown in FIG. 4) or another server system 301. For example, communication interface 315 may receive requests from user system 202 via the Internet, as illustrated in FIGS. 2, 3A, and 3B.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory areas 210 (shown in FIG. 4) and 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

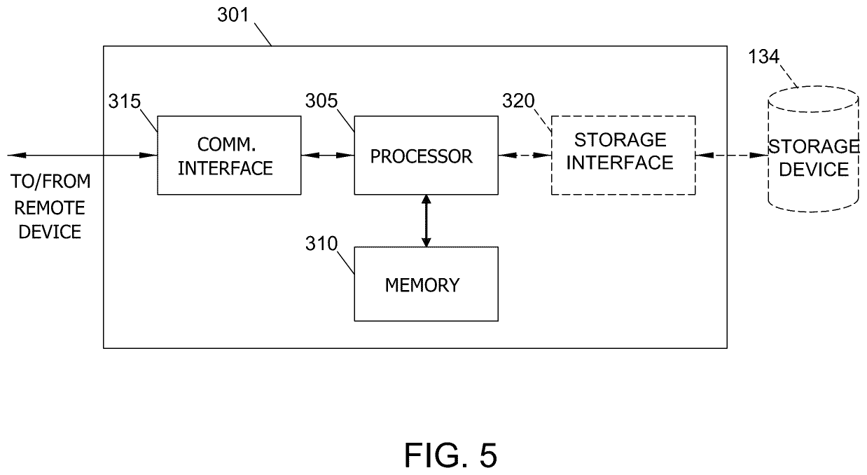

FIG. 6 is flow chart of an example method 600 of merging heterogeneous data types using AI-based tools including LLMs (LLMTM and LLPTM) and RNNs while maintaining data security. In the example embodiment, method 600 is implemented using a computer device coupled to a memory device. Method 600 includes receiving 602 a first corpus of first data, wherein the first data includes an indicator of an interaction between a first element of the first corpus of first data and a second element of the first corpus of first data. Method 600 further includes receiving 604 a second corpus of second data, wherein the second data includes an indication of an interaction between a third element of the second corpus of second data and a fourth element of the second corpus of data, and generating 606 a third matrix using correlations of the first and second elements with correlations of the third and fourth elements.

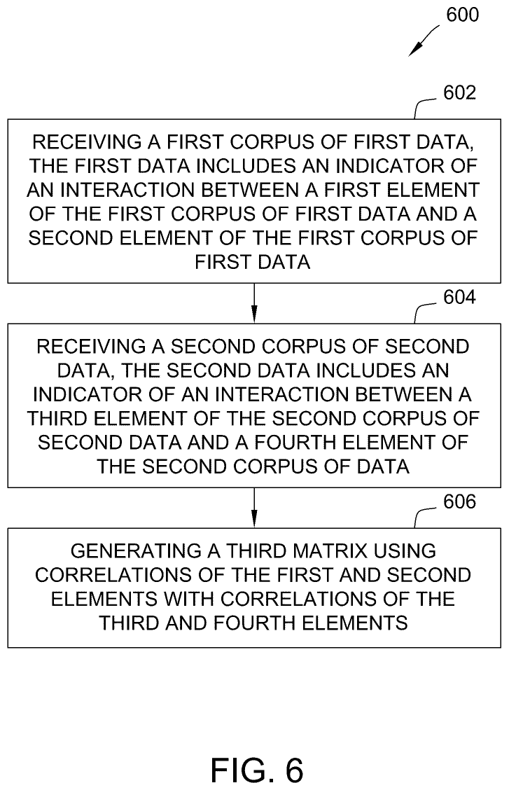

FIG. 7 is a diagram of a correspondence matrix 700 generated by AI-based prediction recommender system 34 (shown in FIG. 1) in accordance with the example embodiment of the present disclosure. In the example embodiment, a first matrix 702 includes a plurality of rows 704 and columns 706, the intersection of each forms a cell 708. Each row represents a merchant and/or merchant location ordered in a predetermined order and each column also represents a merchant and/or merchant location in the same order or a different predetermined order. Each cell 708 represents a number of interactions between each merchant location that intersects at that cell 708. An interaction typically represents a financial transaction by a cardholder that takes place at both merchant locations that make up the intersection. For example, a cardholder that shops at a first store typically has a tendency to shop at a complementary second store and the number of interactions that would be tallied as co-visits to those two stores would be relatively high. It could also be tallied for merchant interactions including online interactions. For example, the first store and second store may be located geographically near each other making visits to both stores convenient for the cardholder. Other stores would typically have different tallies of co-visits with the first store. Therefore, the tallies of co-visits for each store can be weighted according to their total co-visits. Such a weighted list can be used to recommend another merchant location to a cardholder that has expressed an interest in the first merchant location, such as, by browsing a web site associated with the first store.

As described herein, the first matrix 702 of merchants (M×M) and/or merchant locations may be generated from data processed over a payment network and may be considered a merchant transaction GPT or Large Language Merchant Transaction Model that may be executed to form the first matrix 702. The LLM model of merchant data may include a variety of data that needs to be organized into a vector for further analysis in the first matrix 702.

A second matrix 710 includes a plurality of rows 712 and columns 714, the intersection of each forms a cell 716. Each row 712 represents product data of a selectable merchant location ordered in a predetermined order and each column 714 also represents product data of a selectable merchant location in the same order or a different predetermined order (P×P). Each cell 716 represents a number of interactions between each product data that intersects at that cell 716. In this case, an interaction typically represents two products that are purchased at a merchant location. A value in each cell indicates a tally of the instances when the products represented by the row and column are purchased together.

As described herein, the second matrix 710 of products (P×P) may be generated from data processed over a payment network and may be considered a product transaction GPT or Large Language Product Transaction Model that may be executed to form the second matrix 710. The LLM model of product data may include a variety of data that needs to be organized into a vector for further analysis in the second matrix 710. In another embodiment, the second matrix 710 may include a particular type of merchant instead of product data. For example, the first matrix may include all merchants except for restaurants while the second matrix includes only restaurants. In that case, the prediction system 34 may output either restaurant recommendations to the user based on other merchants visited or other merchant recommendations based on the restaurants visited.

A third matrix 718 includes a plurality of rows 720 and columns 722, the intersection of each forms a cell 728. Third matrix 718 is mirrored about a diagonal axis 726 of correspondence matrix 700 due to the construction of matrices 702, 710, and 718. Third matrix 718 is formed by extending rows 704 and columns 706 of first matrix 702 by rows 712 and columns 714 of second matrix 710. The combination of first matrix 702 and second matrix 710 is formed using a key defined by the interactions between the first and second elements (defined by rows 704 and columns 706) and the interactions between the third and fourth elements (defined by rows 712 and columns 714), where the combination of first and second matrices 702, 710 includes generating the third matrix using at least one of an exact key, an overlapping key, and a non-overlapping key. Each row 720 represents product data at the merchant locations (P×M) and each column 722 represents product data at the merchant locations. Each cell 728 represents a number of interactions between each product data at the merchant locations that intersects at that cell 728. In this case, an interaction typically represents two products that are purchased at the same or different merchant locations. A value in each cell indicates a tally of the instances when the products are purchased at merchant locations represented by the row and column are purchased together. For example, an online retailer or merchant may have merchant partners that sell the same products as the online retailer. The merchant and online retailer may be partners in the sense that including the merchant's products on the retailer's website increases sales of the merchants products while the online retailer receives a fee for hosting the product on its website. Using third matrix 718, online retailer may recommend to a cardholder browsing its website a product that the online retailer also sells. This may not affect the revenue of the online retailer because the fee charged to the merchant may offset the lost net revenue of not making the sale itself. Thus, making a recommendation to a cardholder of a product sold by a different merchant location may improve a cardholder's level of satisfaction with the transaction and the standing of the online retailer in the eyes of the cardholder.

In various embodiments, the merge of the networks is defined based on the available “key,” of which there are for example, three types: (1) an Exact Key where the financial transaction data includes a personal account number (PAN), a merchant code (MCC), a date/time of the transaction, and an amount of the transaction; (2) an Overlapping/Approximate Key that includes the MCC, date/time of the transaction, and an amount of the transaction; and (3) a Non-Overlapping Key that includes a proprietary customer identifier with no tie in to the financial transaction data.

The exact key is available when customers have “opted in” as cardholders. Typically, customers who opt-in do so to permit personalized information to be returned to them. This opt-in also permits generation of third matrix 718 by prediction recommender system 34. Once third matrix 718 is formed, the keys are no longer used. If a specific cardholder is to be targeted with a personalized offer, their vector of past purchases can be applied to third matrix 718 to generate specific recommendations. The uploaded merchant data can then be matched precisely based on a key like the example above. One-to-one personalization by leveraging the data within and across networks can be achieved using a recommender. Other traditional modeling and segmentation techniques can be applied with the cardholder as a member of a segment. Also note that a customer of a participating merchant does not have to opt in to receive recommendations if that merchant passes along a product vector (of past purchases, or items in a cart, etc.).

The overlapping/approximate key is available in cases where merchants may not have a large opt-in customer base, so the merge is performed using an approximate key (without a PAN). Microsegment targeting is possible with an approximate match, where a microsegment may have fewer than tens of members. Third matrix 718 is still able to be populated approximately.

The non-overlapping key is available when the proprietary customer identifier used in the key has no tie in to the financial transaction data. In some cases, some merchants may wish to only populate the second matrix of the correspondence matrix using their own proprietary product identifier, thus allowing one-to-one personalization of existing customers independent of the financial transaction data. This allows merchants to enable one-to-one personalization of only their product space. It also enables the use of non-financial transaction data transactions.

In a specific example for the exact key scenario, if a customer used a payment card to buy a camping stove (corresponding to a specific column of third matrix 718), then every merchant where the payment card was used (in a given time window) would receive an incremental bump in the interactions tallied in each of the cells along that column. With enough other customers also using their payment cards, the more meaningful interactions would accumulate greater value and start to stand out. For example, interactions between the camping stove product and staying a KOA campgrounds would typically accumulate greater tallies than interactions between the camping stove product and making a purchase at, for example, Starbucks. There would be customers who purchase a camping stove and also make a purchase at Starbuck's, but over time, with more customer transactions being evaluated, the interactions of customers who purchase a camping stove and also stay at a KOA campground would overwhelm the interactions of the customers who purchase a camping stove and also made a purchase at Starbuck's. This difference is used by a recommender system to provide more reliable recommendations.

In an example of a partially overlapping key the merchant transmits a batch of transactions for the camping stove column of third matrix 718 to prediction recommender system 34 or the batch of transaction are made accessible to prediction recommender system 34:

TABLE 1

| Column Number | Date Time | Amount | Location |
|---|---|---|---|
| 888 | 201507021159 | $172.64 | 452 |
| 888 | 201507020913 | $36.59 | 452 |
| 888 | 201507030834 | $65.22 | 371 |

AI-based prediction recommender system 34 locates PANs that match the transactions transmitted and reinforces the merchants that have seen all matching PANs in the give timeframe by incrementing the value in the cell at the intersection of the merchant and the camp stove. For example, two different cardholders may have come in to store #452 on July 2^{nd} at 9:13 AM and bought the same camping stove (as their only item) and match on row two above. In some cases, a perfect match cannot be assured and likely matches are then incremented. Valuable information is still captured in the tallies of the interactions, even with this imperfect data.

Another cross example between “products” and “merchants” is “staying in a room at Castle XYZ,” which is a product that a travel-oriented merchant may offer. In this case the merchant may be a broker or intermediary that takes payment and arranges for the accommodations. Such an arrangement makes the transactions look like they are occurring at the same location, for example, a headquarters location of the merchant rather than the actual location of the accommodation. So the uploaded data for several visitors to that castle might look like:

TABLE 2

| Column Number | Date Time | Amount | Location |
|---|---|---|---|
| 222 | 201507021159 | $150.37 | 452 |
| 222 | 201507120913 | $300.01 | 452 |
| 222 | 201506290834 | $450.89 | 452 |

Because the merchant is a broker and maybe an online only entity, their location would always be the same, and the actual location of the accommodation would be unknown unless the merchant also provides that information. Also note that in the overlapping key scenario, it's possible that multiple transactions could match on a given day if the multiple transactions had the same checkout date and amount.

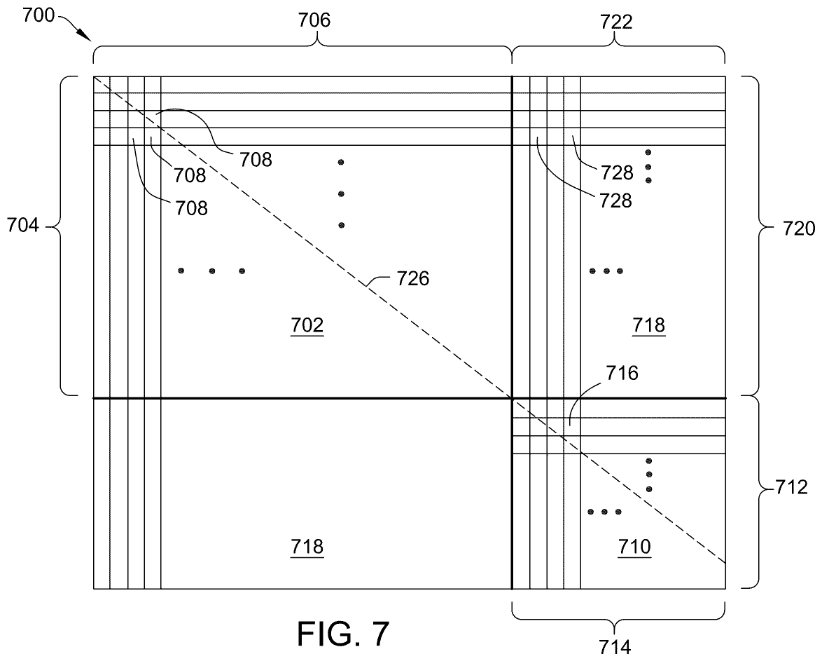

FIG. 8 is a schematic block diagram of AI-based prediction recommender system 34 in accordance with an example embodiment of the present disclosure. In the example embodiment, prediction recommender system 34 is configured to interface with payment card network 28 to receive financial transaction data 800. A first matrix generator 802 is configured to generate a first matrix 804 of merchant locations using a Large Language Merchant Transaction Model. A tally of interactions between merchant locations is used to populate the first matrix. The interactions between merchant locations is determined from financial transaction data 800 by first matrix generator 802. Prediction recommender system 34 is also configured to receive product data 806 from one or more of merchants 24. A second matrix generator 808 is configured to generate a second matrix 810 of product data using a Large Language Product Transaction Model. A tally of interactions between product data is used to populate second matrix 810. Prediction recommender system 34 is further configured to generate a third matrix 812 using a matrix calculator 814 that combines the first matrix and the second matrix with the third matrix 812. Third matrix 812 is used by a list generator 816 to generate weighted lists of recommended products and merchants to a cardholder 22 and/or customers 818 visiting a website of merchant 24 from whom product data 806 was received.

As described above, the AI-based prediction recommender system 34 is configured to mathematically combine (i) the first matrix 804 of merchants (M×M) with (ii) the second matrix 810 of product data (P×P) with (iii) the third matrix 812 of product to merchant (P×M) data and then with (iv) the preference vector that includes recent purchase data for a selected cardholder or set of cardholders. The preference vector includes a merchant portion and a product portion. In some cases, the system may have both of those portions of data. But typically, the system may only have one portion or the other, or a partial portion of each of the preference vector. The preference vector is combined with the matrices to iteratively generate a propagated activation vector or model that outputs a targeted and customized recommendation for the selected cardholder or set of cardholders of a product or merchant that the cardholder(s) will likely interact with and/or purchase from. This output may then be provided to the cardholder(s) in real-time through a website, a computer app executing on a mobile device of the user, a kiosk, or pushed to the cardholder's mobile phone based on location data provided by the phone.

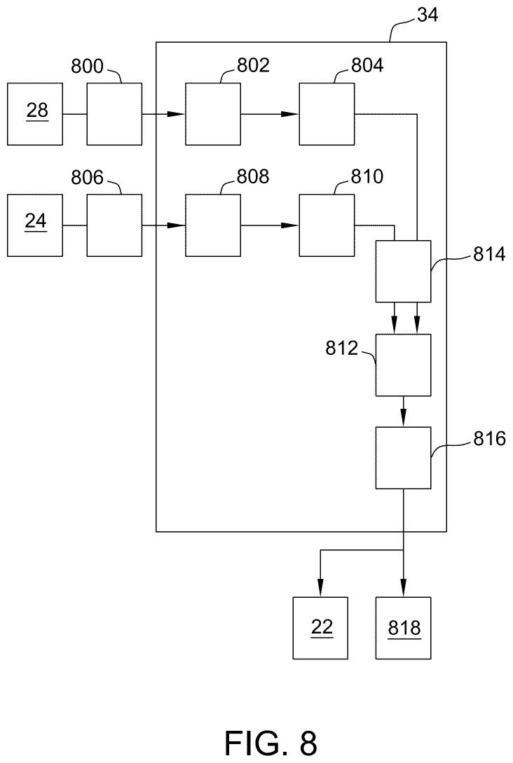

FIG. 9 is a data flow diagram 900 of AI-based prediction recommender system 34 in accordance with one or more example embodiments of the present disclosure. In the example embodiment, prediction recommender system 34 includes at least first matrix generator 802, second matrix generator 808, matrix calculator 814, and list generator 816. First matrix generator 802 is configured to receive financial transaction data 902 relating to purchases made by a plurality of cardholders 22 using payment card network system 100. This transaction data 902 may be considered a merchant transaction GPT or Large Language Merchant Transaction Model that may be executed to form the first matrix. First matrix generator 802 is configured to receive other cardholder interactions 904 relating to one or more merchants' non-payment card network venues 906, such as, via a website, social media, telecommunications, and the like.

Second matrix generator 808 is configured to receive product data 908 relating to products purchased by a plurality of cardholders 22 using payment card network system 100. The product data 908 may be considered a product transaction GPT or Large Language Product Transaction Model that may be executed to form the second matrix. First and second matrix generators 802, 808 are configured to generate respective first matrix 910 and second matrix 912 from these LLMs. First matrix 910 and second matrix 912 may be stored in a particular database 914 configured to improve a performance of processors, for example, processors 205, 305 by processing the huge size of first matrix 910 and second matrix 912 and temporary calculation results generated when organizing or combining first matrix 910 and second matrix 912. First matrix 910 and second matrix 912 may be segregated in database 914 or may be commingled in database 914 according to a particular algorithm executing. First matrix 910 and second matrix 912 may be combined by matrix calculator 814 to form a third matrix 916. In some cases, third matrix 916 may be formed using enriched data that may be acquired as part of the transactions being performed with a co-branded card or the enriched data may be provided by another party to the system and probability determinations are made using that data to further enhance the data to be used to generate the third matrix 916.

Because matrix calculator 814 is capable of combining first matrix 910 and second matrix 912 in a plurality of ways, and is capable of using enriched data to create the third matrix 916, the third matrix 916 can be of many different forms. Matrix calculator 814 helps top create third matrix 916 by updating the individual cells of the third matrix with new financial transaction data 902 received from payment card network 28.

A list generator 816 is configured to mathematically combined the three matrices with a preference vector 918 that includes recent purchase data for a selected cardholder or set of cardholders. The preference vector includes a merchant portion and a product portion. In some cases, the system may have both portions. But typically, the system may only have one portion or the other, or a partial portion of each. The preference vector is combined with the three matrices by the list generator 816 to iteratively generate a propagated activation vector or model 920 that outputs a targeted and customized recommendation for the selected cardholder or set of cardholders of a product or merchant that the cardholder(s) will likely interact with and/or purchase from. This output may then be provided to the cardholder(s) through a website, an app on a mobile device, a kiosk, or pushed to the cardholder or other users, such as, a requester 922.

Prediction recommender system 34 may update first matrix 910, second matrix 912, and/or third matrix 916 using Recurrent Neural Networks (RNNs) and/or generative Artificial Intelligence (AI) techniques. RNNs and generative AI are closely related in the field of machine learning. RNNs are a type of neural network architecture that may have a feedback loop that enables them to process sequence of input data (e.g., time series and text data) by maintaining an internal state and passing it along to the next step. In other words, RNNs have a feedback mechanism that allows information to persist and be passed from one step to the next. This makes RNNs well-suited for processing tasks involving sequences such as natural language processing, speech recognition, and time series analysis. Generative AI refers to algorithms, models, or systems that can generate new content (e.g., images, text, music, scenarios, or the like) that resembles the training data it was exposed to. RNNs can be utilized in building generative AI models to capture dependencies and patterns in sequential data, enabling RNNs to generate coherent and contextually relevant outputs.

In particular, a type of RNN called the “Recurrent Generative Adversarial Network” (RGAN) has been used for generative tasks. RGANs combine the power of RNNs with the framework of Generative Adversarial Networks (GANs) to generate realistic and coherent sequences, such as text or music. One application of RNNs in generative AI is in building RNN-based models, which can generate coherent and context-aware text. For example, RNN-based models like Recurrent Neural Network Language Models (RNNLMs) or variants such as Long Short-Term Memory (LSTM) or Gated Recurrent Units (GRUs) are commonly used. RNN-based models can be trained on large text corpora and learn the statistical patterns and dependencies in the data (e.g., product or item data, transaction data, and other data that may be used in matrices, 910, 912, 916, and 918). Once trained, they can generate new data (e.g., predictions in the form of text, numbers, stories, or the like) based on the learned patterns, which is an example of generative AI.

By using RNNs as the generator component in a GAN architecture, the RNN-based models can learn to generate new sequences that capture the patterns and structures of the training data. The generator RNN receives random input or a seed sequence and generates new samples, while the discriminator part of the GAN distinguishes between the generated samples and real samples, providing feedback to improve the generator's performance. The RNN-based models can be further enhanced with techniques like attention mechanisms or variational autoencoders to improve their performance and generate more realistic and diverse outputs. In summary, RNNs provide a framework for capturing sequential dependencies, and when applied to generative AI tasks, they can generate new and coherent content or sequences based on patterns learned from the training data.

In addition, prediction recommender system 34 may use PageRank® (PageRank is a registered trademark of Google LLC, Mountain View, California) to process data in matrices 910, 912, 916, and 918 and provide outputs from matrices 910, 912, 916, and 918. PageRank is a link analysis algorithm used by search engines to rank web pages based on their relevance and importance. PageRank is based on the idea that a web page is important if other important pages link to it. In other words, PageRank uses a recursive algorithm to calculate the importance of a web page based on the number and quality of links pointing to the webpage. PageRank uses an iterative approach to assign a numerical value, known as the PageRank score, to each webpage in a web graph. The algorithm iteratively updates the score of each webpage based on the scores of the pages linking to it.

In scenarios where the web graph is dynamic or evolving, RNNs can be utilized to capture temporal dependencies and update PageRank scores accordingly. RNNs can be employed as a component in enhancing the accuracy and efficiency of the PageRank algorithm. RNNs can learn to capture the sequential dependencies between web pages, which can help identifying the most important pages in a web graph more accurately. By incorporating an RNN, the algorithm can consider the chronological order of link updates and adjust the importance of web pages accordingly. The RNN can learn from the sequential patterns of link changes, such as new links being added or existing links being removed. That is, the RNN helps updating the PageRank scores iteratively while taking into account the evolving nature of the web graph. This dynamic approach allows for more accurate and up-to-date rankings, particularly in scenarios where the link structure of the web is subject to frequent changes.

For example, one way to use RNNs in PageRank is to create a sequence of web pages, where each page is represented by a vector of features (e.g., the number of links pointing to the page, the number of words of the page, or the like). The RNN is then trained to predict the importance score of each page, given the sequence of features for all pages in the web graph. Once the RNN has been trained, it can be used to rank the importance of web pages in a more accurate and efficient way. For instance, when a new web page is added to the web graph, the RNN can be used to update the importance scores of all the pages in the graph, without having to recalculate the entire graph.

Another possible application is to incorporate RNNs for personalized PageRank. By considering a user's browsing history or preferences, an RNN can learn to capture the user's interests and biases. This information can then be used to adjust the PageRank scores accordingly, providing a personalized ranking of web pages for the user. Another use case is to leverage RNNs for link prediction. RNNs can be trained to analyze the sequence of links that users click on and predict the likelihood of future links they might click. By incorporating these predictions into the PageRank algorithm, the ranking of web pages can be further refined to improve outputs provided by the PageRank algorithm which may result in enhanced user experience.

While these are few examples, it's important to note that RNNs can be integrated into related techniques to enhance the accuracy and relevance of search results based on user-specific data or to predict the evolution of the link structure over time.

In some embodiments, prediction recommender system 34 may apply RNNs, generative AI, and/or PageRank to the received transaction data to train the data to create matrices 910, 912, 916, and/or 918 to (a) update matrices 910, 912, 916, and/or 918, and (b) generate propagated activation vector 920 of predictions of recommended merchants and/or products that are output to cardholder 22 or other users, such as, a requester 922.

For example, prediction recommender system 34 may provide predictions to cardholder 22 or other users related to actual products in a store or in a virtual catalog, including, but not limited to, a rewards redemption catalog. In one example, prediction recommender system 34 may use third matrix 916 or any number of additional matrices in combination with the preference vector and artificial intelligence tools, also referred to as computer techniques (e.g., RNNs, Generative AI, and/or PageRank), to determine and provide predictions or recommendations (e.g., a list of products or items, a restaurant menu, or the like) based on parameters (e.g., type of predictions to be determined/provided) that a user of prediction recommender system 34 may input into prediction recommender system 34. In some embodiments, prediction recommender system 34 may use matrices 916 and 918 to determine the spending behavior of cardholder 22 and other users, and generate results, such as spending predictions or recommendations based on the determined spending behavior.

In some embodiments, prediction recommender system 34 may determine dynamic recommendations via a computer application provided by prediction recommender system 34 to a user computing device (e.g., client systems 114, 115 and/or input device 119 all shown in FIG. 2) of cardholder 22 or other users. The computer application may be executed on the user computing device and may enable cardholder 22 to opt in to use spending behavior associated with an account of cardholder 22 card to determine and provide recommendations without sharing or exposing transaction data associated with the account or personal identifiable information (PII) of cardholder 22,

In other embodiments, prediction recommender system 34 may use third matrix 916 or any number of additional matrices in combination with the preference vector 918 and computer techniques (e.g., RNNs, Generative AI, and/or PageRank), to determine and provide a variety of results. For example, these results may include: (a) an estimate of demand for a new item (e.g., an item lacking demand history) by identifying a similar item having demand (e.g., data included in matrices 916 and 918) and mapping this demand to the new item demand; (b) recommendations related to implementation of item endcaps in physical stores by analyzing the spending behavior of a subset of accounts having data in, for example, matrices 916 and 918; (c) loyalty redemption catalogs constructed based on a relationship between first matrix 910 (e.g., data associated with account spend behavior) and second matrix 912 (e.g., data associated with items redeemed); (d) enhanced, personalized online shopping recommendations for each cardholder 22 by enabling cardholder 22 to opt in on a computer application, executing on a user computing device of cardholder 22 and provided by prediction recommender system 34, configured to use an account on file of cardholder 22 to personalize recommendations for items in a store; and (c) instant recommendations for in-store items at a store using an computer interface between (i) prediction recommender system 34 and (ii) a stored computer application or a store/merchant computer device, where geofence technology enables detecting cardholder 22 has entered the store and triggering the computer interface to activate, such that prediction recommender system 34 may determine and provide the instant recommendations via the stored computer application. In summary, prediction recommender system 34 improves the processing performance (e.g., processing speed) of processors, for example, processors 205, 305 (both shown in FIGS. 4 and 5) by implementing the matrices and AI techniques, discussed herein. In particular, prediction recommender system 34 provides a real-time process of complex computational relationships, via a particular computational scheme, of a much broader (relative to conventional systems) set of data, thereby providing technical solutions to technical performance limitations of conventional computer recommender systems.

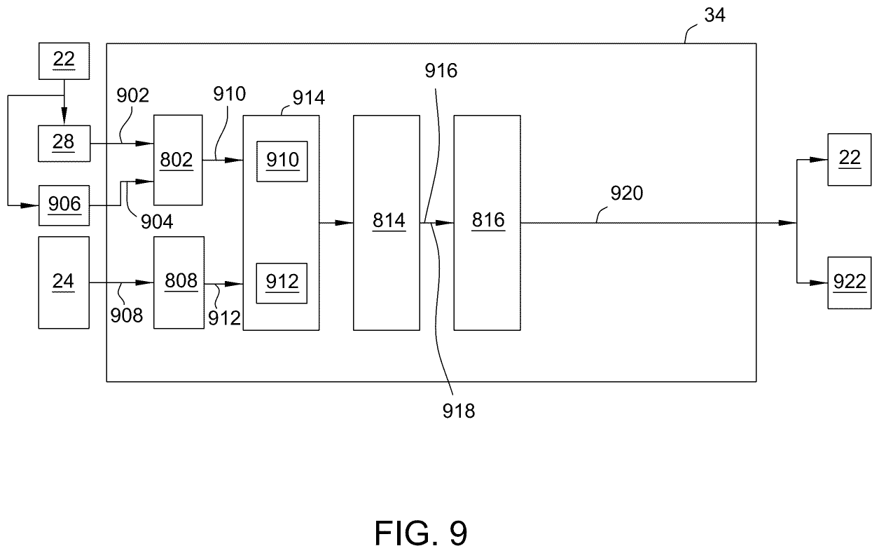

FIG. 10 is a schematic diagram 1000 showing generative artificial intelligence (AI) operations that include a recurrent neural network (RNN) feedback loop and Large Language Models (LLMs) using a prediction recommender system 34 in accordance with an example embodiment of the present disclosure. In the example embodiment, prediction recommender system 34 includes a database 1002 (similar to database 914 shown in FIG. 9) for storing a plurality of transaction data, a matrix 1004 (similar to first matrix 702, second matrix 710 and third matrix 718 all shown in FIG. 7; and first matrix 910, second matrix 912 and third matrix 916 all shown in FIG. 9), a preference vector 1006 (also referred to as preferred history vector or product vector) that may include a merchant portion and a product portion, and a propagated activation vector 1008 (also referred to as predictive model or predictive vector model). In the example embodiment, database 1002 stores matrix 1004. In some embodiments, database 1002 may also store preference vector 1006 and/or propagated activation vector 1008. In the example embodiment, matrix 1004 includes a plurality of rows and columns including numerical vectors (not shown) representing data associated with a plurality of merchants (e.g., Merchant by Merchant (M×M)). In some embodiments, the numerical vectors may represent data associated with a plurality of products (e.g., Product by Product (P×P)). In some embodiments, the matrix 1004 includes multiple matrices including a merchant by merchant, a product by product, and a product by merchant relationship.

As described herein, AI-based prediction recommender system 34 is configured to receive transaction data and generate a first matrix of merchants (M×M) and/or merchant locations. The received and stored merchant data may be considered a merchant transaction GPT or Large Language Merchant Transaction Model that may be executed to form the first matrix. The LLM model of merchant data may include a variety of data that needs to be organized into a vector for further analysis in the first matrix. Prediction recommender system 34 is also configured to receive product data and generate a second matrix of product data (P×P). The received and stored product data may be considered a product transaction GPT or Large Language Product Transaction Model that may be executed to form the second matrix. The LLM model of product data may include a variety of data that needs to be organized into a vector for further analysis in the second matrix. This can be done using RNN and/or ChatGPT tools. The AI-based prediction recommender system 34 is further configured to generate a third matrix that combines known (data gathered as a result of a co-brand card being used) or determined (probabilistic determination from limited or anonymous data) product to merchant (P×M) data that is then mathematically combined with the first matrix and the second matrix. The third matrix is used to help build relationships between merchants and products.

Prediction recommender system 34 may generate and update matrix 1004 using a Generative Artificial Intelligence (AI) operations including at least one Large Language Model (LLM). For example, prediction recommender system 34 may use the at least one LLM to generate matrix 1004 including the plurality of rows and columns, where the intersection of each row and column forms a cell. Each row represents a merchant location ordered in a predetermined order and each column also represents a merchant location in the same order or a different predetermined order. Each cell represents a number of interactions between each merchant location that intersects at that the cell. An interaction typically represents a transaction by a cardholder that takes place at both merchant locations that make up the intersection.

In the embodiment shown in FIG. 10, prediction recommender system 34 may combine matrix 1004 with preference vector 1006 to generate propagated activation vector 1008 that may output predictions in the form of recommendations. Preference vector 1006 may include a merchant portion of the vector and a product portion of the vector. The preference vector 1006 includes recent purchase data for a selected cardholder or set of cardholders. In some cases, the system may have both portions, the merchant portion and the product portion. But typically, the system may only have one portion or the other, or a partial portion of each. In some embodiment, the preference vector 1006 includes numerical vectors representing one or more primary account numbers (PANs) and/or one or more products that an interested party (e.g., a merchant) might want to sell, such that the propagated activation vector 1008 may output predictions associated with the data represented by the numerical vectors.

In addition, prediction recommender system 34 may use propagated activation vector 1008 to feedback 1010 (e.g., an RNN feedback loop) into preference vector 1006 and/or the numerical vectors in matrix 1004 as a recurrent neural network (RNN), such that input data into matrix 1004 may be processed sequentially while maintaining the internal state of the input data when passing the input data along to the next step (e.g., applying preference vector 1006 to matrix 1004). By using iterative feedback 1010, prediction recommender system 34 may refine preference vector 1006 and/or matrix 1004, thereby improving accuracy of the output of predictions by propagated activation vector 1008. More specifically, feedback 1010 enables additional weighting aspects to be included back into the preference vector 1006 so that additional activation may be outputted or shown in the propagated activation vector 1008, thereby providing a propagation model that more accurately identifies the correspondence or overlap between the selected cardholder or cardholders purchasing preferences in combination with the purchasing history of the other cardholders. The result is a propagated activation vector 1008 that accurately and in real-time is able to provide targeted and customized recommendations for the selected cardholder or set of cardholders of a product or merchant that the cardholder(s) will likely want to interact with and/or purchase items from. This output may then be provided to the cardholder(s) through a website, an app on a mobile device of the cardholder, a kiosk near or at a merchant, or pushed to the cardholder's mobile device periodically or when the cardholder enters or is proximate to an identified merchant.

In one example, prediction recommender system 34 may apply preference vector 1006 (e.g., a cardholder vector of past purchases) to the numerical vectors in matrix 1004 to output propagated activation vector 1008 including specific recommendations for a specific cardholder, such as (i) a personalized recommendation of one or more merchants to the cardholder, (ii) a merchant related recommendation, or (iii) any type of recommendation that may be requested by a requestor. In another example, prediction recommender system 34 may apply preference vector 1006 (e.g., a product vector) to the numerical vectors in matrix 1004 to output propagated activation vector 1008 including one or more of the following recommendations: (i) a product recommended endcap at a merchant store, (ii) a recommended new menu for a restaurant, (iii) a recommended product to display on a webpage for potential purchasers, (iv) a recommended loyalty catalog for potential purchasers, (v) a product related recommendation, and/or (vi) any type of recommendation that may be requested by a requestor.

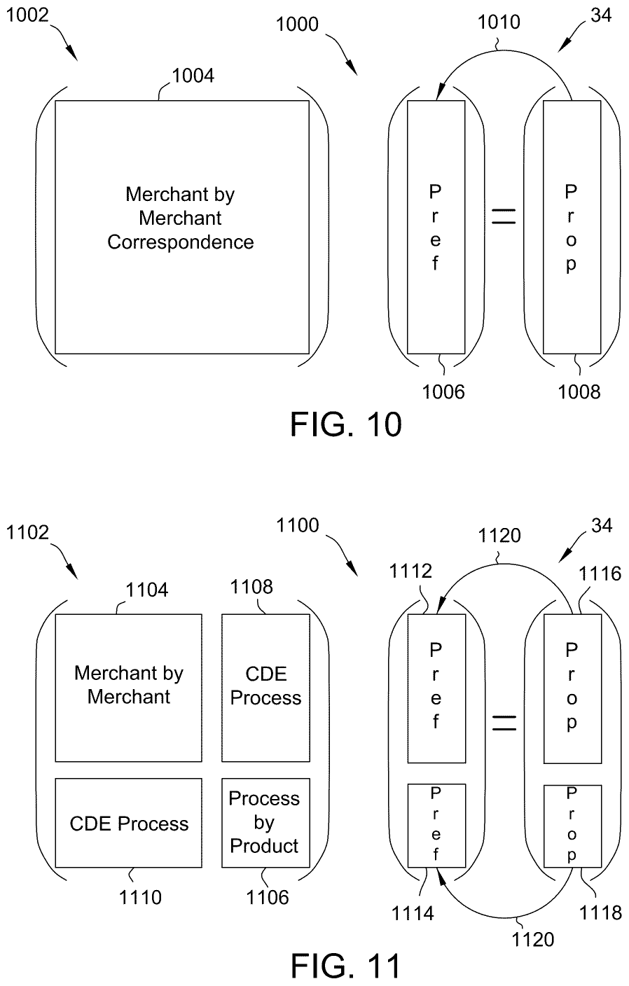

FIG. 11 is a schematic diagram 1100 showing generative artificial intelligence (AI) operations that include a recurrent neural network (RNN) feedback loop and Large Language Models (LLMs) using a prediction recommender system 34 in accordance with an example embodiment of the present disclosure. In the example embodiment, prediction recommender system 34 includes a database 1102 (similar to database 914 shown in FIG. 9), a first matrix 1104 (similar to first matrix 702 shown in FIG. 7 and first matrix 910 shown in FIG. 9), a second matrix 1106 (similar to matrix 710 shown in FIG. 7 and second matrix 912 shown in FIG. 9), third matrices 1108 and 1110 (each similar to matrix 718 shown in FIG. 7 and matrix 916 shown in FIG. 9), preference vectors (merchant portion) 1112 and 1114 (product portion) (each similar to preference vector 1006 shown in FIG. 10), and propagated activation vectors 1116 (merchant portion) and 1118 (product portion) (each similar to propagated activation vector 1008 shown in FIG. 10). In the example embodiment, database 1102 stores matrices 1104, 1106, 1108, and 1110. In some embodiments, database 1102 may also store preference vectors 1112, 1114 and/or propagated activation vectors 1116, 1118.

In the example embodiment, first matrix 1104 includes a plurality of rows and columns including numerical vectors (not shown) representing data associated with a plurality of merchants (e.g., Merchant by Merchant (M×M)) and second matrix 1106 includes a plurality of rows and columns including numerical vectors representing data associated with a plurality of products (e.g., Product by Product (P×P)).

As described above, AI-based prediction recommender system 34 is configured to receive transaction data and generate the first matrix 1104 of merchants (M×M) and/or merchant locations. The received and stored merchant data may be considered a merchant transaction GPT or Large Language Merchant Transaction Model that may be executed to form the first matrix. The LLM model of merchant data may include a variety of data that needs to be organized into a vector for further analysis in the first matrix. Prediction recommender system 34 is also configured to receive product data to generate the second matrix 1106 of product data (P×P). The received and stored product data may be considered a product transaction GPT or Large Language Product Transaction Model that may be executed to form the second matrix. The LLM model of product data may include a variety of data that needs to be organized into a vector for further analysis in the second matrix. This can be done using RNN and/or ChatGPT tools. The AI-based prediction recommender system 34 is further configured to generate the third matrix 1108 and 1110 that combines known (data gathered as a result of a co-brand card being used) or determined (probabilistic determination from limited or anonymous data) product to merchant (P×M) data that is then mathematically combined with the first matrix 1104 and the second matrix 1106. The third matrix is used to help build relationships between merchants and products. This multiple matrix data structure is then stored in database 1102.

Prediction recommender system 34 may generate and update first matrix 1104 similarly to matrix 1004 (shown in FIG. 10). Prediction recommender 34 may also generate and update second matrix 1106 using generative Artificial Intelligence (AI) operations including at least one Large Language Model (LLM). For example, prediction recommender system 34 may use the at least one LLM to generate second matrix 1106 including the plurality of rows and columns (not shown), where the intersection of each row and column forms a cell. Each row represents product data of a selectable merchant location ordered in a predetermined order and each column also represents product data of a selectable merchant location in the same order or a different predetermined order. Each cell represents a number of interactions between each product data that intersects at that cell. An interaction typically represents two products that are purchased at a merchant location. A value in each cell indicates a tally of the instances when the products represented by the row and column are purchased together.

Prediction recommender system 34 may further generate third matrices 1108, 1110 (e.g., Merchant by Product (M×P) and Product by Merchant (P×M)) by linking the first and second matrices using a key including at least one of an exact key, an overlapping key, and a non-overlapping key. Each of third matrices 1108, 1110 includes a plurality of rows and columns, where the intersection of each forms a cell. Similar to third matrix 718, each of third matrices 1108, 1110 is formed by extending the rows and columns of first matrix 1104 by the rows and columns of second matrix 1106. The combination of first matrix 1104 and second matrix 1106 is formed using the key defined by interactions between first and second elements (defined by rows and columns of first matrix 1104) and interactions between third and fourth elements (defined by rows and columns of second matrix 1106). Each row of each third matrix 1108, 1110 represents product data at the merchant locations and each column of each third matrix 1108, 1110 represents product data at the merchant locations. Each cell of each third matrix 1108, 1110 represents a number of interactions between each product data at the merchant locations that intersects at that cell. In this case, an interaction typically represents two products that are purchased at the same or different merchant locations. A value in each cell indicates a tally of the instances when the products are purchased at merchant locations represented by the row and column are purchased together.

Once third matrix 1108 and/or third matrix 1110 is created, prediction recommender 34 system may mathematically combine third matrices 1108, 1110 with the first matrix 1104 and the second matrix 1106 and with preference vector portions 1112, 1114. For example, prediction recommender system 34 may mathematically combine the matrices 1104/1106/1108/1110 with preference vector merchant portion 1112 to generate a propagated activation vector 1116 that may output predictions in the form of recommendations regarding other merchants the cardholder may be interested in patronizing and/or in some cases products the cardholder may be interested in purchasing. Similarly, the three matrices 1104/1106/1108/1110 may be mathematically combined with preference vector product portion 1114 to generate a propagated activation vector 1118 that may also output predictions in the form of recommendations regarding other products the cardholder may be interested in purchasing and/or in some cases merchants the cardholder may be interested in patronizing.

Propagated activation vector portions 1116, 1118 may include numerical vectors. The first portion 1116 includes a merchant portion of the vector. The second portion 1118 includes a product portion. The propagated activation vector 1116/1118 represents a plurality of primary account numbers (PANs) and/or one or more products that an interested party (e.g., a merchant) might want to sell, such that the predictive model may output predictions associated with the data represented by the numerical vectors. In addition, prediction recommender system 34 may use propagated activation vectors 1116, 1118 to feedback 1120 (e.g., an RNN feedback loop) into preference vectors 1112, 1114, third matrices 1108, 1110, second matrix 1106, and/or first matrix 1104 as a recurrent neural network (RNN), such that input data into first and second matrices 1104, 1106 may be processed sequentially while maintaining the internal state of the input data when passing the input data along to the next step (e.g., combining first and second matrices 1104, 1106 and/or applying preference vectors 1112, 1114 to third matrices 1108, 1110). By using feedback 1120, prediction recommender system 34 may refine preference vectors 1112, 1114 and/or matrices 1104, 1106, 1108, 1110, thereby improving accuracy of the output of predictions by propagated activation vectors 1116, 1118.

In one example, prediction recommender system 34 may apply preference vectors 1112, 1114 to matrices 1108, 1110, 1106, and 1104 to output propagated activation vectors 1116, 1118 including recommendations described in FIG. 10. In another example, the recommendations may include: (a) an estimate of demand for a new item (e.g., an item lacking demand history) by identifying a similar item having demand (e.g., data included in third matrices 1108, 1110) and mapping this demand to the new item demand; (b) recommendations related to implementation of item endcaps in physical stores by analyzing the spending behavior of a subset of accounts having data in, for example, third matrices 1108, 1110; (c) loyalty redemption catalogs constructed based on a relationship between first matrix 1104 (e.g., data associated with account spend behavior) and second matrix 1106 (e.g., data associated with items redeemed); (d) enhanced, personalized online shopping recommendations for a specific cardholder by enabling that cardholder to opt in on a computer application, executing on a user computing device of the cardholder and provided by prediction recommender system 34, configured to use an account on file of the cardholder to personalize recommendations for items in a store; and (e) instant recommendations for in-store items at a store using an computer interface between (i) prediction recommender system 34 and (ii) a stored computer application or a store/merchant computer device, where geofence technology enables detecting the cardholder has entered the store and triggering the computer interface to activate, such that prediction recommender system 34 may determine and provide the instant recommendations via the stored computer application.

Additionally or alternatively, prediction recommender system 34 may use Generative AI, LLMs, RNNs, matrices 1104, 1106, 1108, 1110 preference vectors 1112, 1114, and propagated activation vectors 1116, 1118 to generate and provide outputs without sharing, or exposing personal identifiable information (PII) of cardholders, merchants, or any requestor of outputs from prediction recommender system 34. Specifically, prediction recommender system 34 is configured to operate using tokenized or anonymized data. For example, in first matrix 1104, the merchant data may include merchant identifiers and/or tokenized account numbers so that the actual merchant name and/or accountholder name or account number is not known to the system. This data may be converted into actual data later after the recommendations are outputted. Similarly, the second matrix 1106 may include product data that is anonymized. For example, the product identifier may include a SKU number that can be used later to identify the actual product. System 34 is configured to use such anonymized while still being able to output accurate predictions.

Prediction recommender system 34 may generate and provide such outputs by (i) generating first matrix 1104 (e.g., M×M matrix) using at least one LLM, (ii) generating second matric 1106 (e.g., P×P matrix) using the at least one LLM, (iii) generate third matrices 1108, 1110 (e.g., M×P matrix and P×M matrix) having numerical vectors generated using the at least one LLM wherein the third matrices are generated from known data (transactions initiated using a co-branded card or where the transaction data is, and (iv) applying preference vectors 1112, 1114 to the third matrices 1108, 1110 and using Generative AI operations to output propagated activation vectors 1116, 1118 including at least one predictive result, such as at least one recommendation.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors associated with merchants, POS devices, mobile devices, or associated with smart infrastructure or remote servers), and/or via computer-executable instructions stored on non-transitory computer-readable media or medium.

In some embodiments, Prediction recommender system 34 is configured to implement machine learning and/or AI techniques, such that Prediction recommender system 34 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to numbers data, text data, images, and/or other types of data. ML outputs may include, but are not limited to identified objects, items classifications, textual products, and/or other data extracted from images or textual data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text or numbers with known characteristics or features. Such information may include, for example, information associated with a plurality of text of a plurality of different questions, responses, objections, items, and/or transaction information.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and prediction recommender system 34 may be configured to utilize artificial intelligence and/or machine learning techniques. In some embodiments, the prediction recommender system 34 may include voice or chatbots for generating and outputting a prediction as described herein. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal outputs, text or textual output, visual or graphical output, output for use with speakers and/or display screens, and/or other types of output for user and/or other computer or bot consumption. These outputs may be created using the matrices and vectors described herein along with the LLMs, RNNs and other AI techniques so that the predictions may be audibly provided using the chatbot to the merchant or the cardholder at the time of purchase or shopping either in the store (e.g., over a mobile device or via the POS) or at an online purchase.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, NoSQL, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network. The technical effect of the methods and systems may be achieved by performing at least one of the following steps: (a) receiving a first corpus of first data, the first data includes an indicator of an interaction between a first element of the first corpus of first data and a second element of the first corpus of first data; (b) generating a first matrix that correlates the interactions between the first element and the second element; (c) receiving a second corpus of second data, the second data includes an indication of an interaction between a third element of the second corpus of second data and a fourth element of the second corpus of data; (d) generating a second matrix that correlates the interactions between the third element and the fourth element; and (e) generating a third matrix by merging the first matrix and the second matrix using a key defined by the interactions between the first and second elements and the interactions between the third and fourth elements.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device, which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

This written description uses examples to describe the disclosure, including the best mode, and also to enable any person skilled in the art to practice the disclosure, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An artificial intelligence (AI)-based prediction recommender system comprising at least one processor and at least one database in communication with the at least one processor, the at least one processor configured to:
generate a first matrix using a large language merchant transaction model including transaction data associated with a first plurality of users, the first matrix correlating a first set of interactions among a first plurality of merchants;
generate a second matrix using a large language product transaction model including transaction data associated with a second plurality of users, the second matrix correlating a second set of interactions among a plurality of products;
generate a third matrix including transaction data associated with a third plurality of users, the third matrix correlating a third set of interactions between products and merchants where the products were purchased;
generate a preference vector associated with at least one accountholder, the preference vector representing historical purchases initiated by the accountholder with a second plurality of merchants;
iteratively calculate a propagated activation vector by mathematically combining the first matrix, the second matrix, the third matrix and the preference vector; and
output a recommendation associated with the at least one accountholder using the propagated activation vector, the recommendation including at least one of a merchant or a product predicted for purchasing by the accountholder.

2. The AI-based prediction recommender system of claim 1, wherein the at least one processor is further configured to: generate at least one of the first matrix, the second matrix and the third matrix using the one or more AI techniques.

3. The AI-based prediction recommender system of claim 2, wherein the at least one processor is further configured to train the one or more AI techniques using the transaction data including merchant data and product data.

4. The AI-based prediction recommender system of claim 2, wherein the one or more AI techniques include at least one of Recurrent Neural Networks (RNNs), Generative AI, or PAGERANK®.

5. The AI-based prediction recommender system of claim 1, wherein the at least one processor is further configured to receive the transaction data from a processing network wherein the transaction data is associated with a plurality of accounts of the first plurality of users.

6. The AI-based prediction recommender system of claim 1, wherein the at least one processor is further configured to receive transaction data from a processing network wherein the transaction data is associated with a plurality of products.

7. The AI-based prediction recommender system of claim 1, wherein the outputted recommendation includes at least one of: (a) an estimate of demand for a new item, (b) recommendations related to implementation of item endcaps in physical stores at the plurality of merchants, (c) loyalty redemption catalogs for at least one the first or second plurality of users, (d) enhanced, personalized online shopping recommendations for at least one the first or second plurality of users, or (e) instant recommendations for in-store items at a store of one of the plurality of merchants.

8. The AI-based prediction recommender system of claim 1, wherein the at least one processor is further configured to interface with a computer application associated with one of the plurality of merchant to: (a) determine one or more instant recommendations for in-store items at a store of the merchant and (b) cause the one or more instant recommendations to be displayed, via the computer application, on a user computing device of one of the first or second plurality of users.

9. A computer-implemented method using an AI-based prediction recommender computing system including at least one processor and at least one database, the method comprising:
generating a first matrix using a large language merchant transaction model including transaction data associated with a first plurality of users, the first matrix correlating a first set of interactions among a first plurality of merchants;
generating a second matrix using a large language product transaction model including transaction data associated with a second plurality of users, the second matrix correlating a second set of interactions among a plurality of products;
generating a third matrix including transaction data associated with a third plurality of users, the third matrix correlating a third set of interactions between products and merchants where the products were purchased;
generating a preference vector associated with at least one accountholder, the preference vector representing historical purchases initiated by the accountholder with a second plurality of merchants;
iteratively calculating a propagated activation vector by mathematically combining the first matrix, the second matrix, the third matrix and the preference vector; and
outputting a recommendation associated with the at least one accountholder using the propagated activation vector, the recommendation including at least one of a merchant or a product predicted for purchasing by the accountholder.

10. The computer-implemented method of claim 9 further comprising generating the first matrix, the second matrix, and the third matrix using the one or more AI techniques.

11. The computer-implemented method of claim 10 further comprising training the one or more AI techniques using the transaction data including merchant data and product data.

12. The computer-implemented method of claim 10, wherein the one or more AI techniques include at least one of Recurrent Neural Networks (RNNs), Generative AI, or PAGERANK®.

13. The computer-implemented method of claim 9 further comprising receiving the transaction data from a processing network wherein the transaction data is associated with a plurality of accounts of the first plurality of users.

14. The computer-implemented method of claim 9 further comprising receiving the transaction data from a processing network wherein the transaction data is associated with a plurality of products.

15. The computer-implemented method of claim 9, wherein the outputted recommendation includes at least one of: (a) an estimate of demand for a new item, (b) recommendations related to implementation of item endcaps in physical stores at the plurality of merchants, (c) loyalty redemption catalogs for at least one the first or second plurality of users, (d) enhanced, personalized online shopping recommendations for at least one the first or second plurality of users, or (e) instant recommendations for in-store items at a store of one of the plurality of merchants.

16. The computer-implemented method of claim 9 further comprising interfacing with a computer application associated with one of the plurality of merchants to (a) determine one or more instant recommendations for in-store items at a store of the merchant and (b) cause the one or more instant recommendations to be displayed, via the computer application, on a user computing device of one of the first or second plurality of users.

17. At least one non-transitory computer-readable storage medium having computer-executable instructions embodied thereon, wherein when executed by at least one processor of a AI-based prediction recommender system, the at least one processor in communication with at least one database, the computer-executable instructions cause the at least one processor to:
generate a first matrix using a large language merchant transaction model including transaction data associated with a first plurality of users, the first matrix correlating a first set of interactions among a first plurality of merchants;
generate a second matrix using a large language product transaction model including transaction data associated with a second plurality of users, the second matrix correlating a second set of interactions among a plurality of products;
generate a third matrix including transaction data associated with a third plurality of users, the third matrix correlating a third set of interactions between products and merchants where the products were purchased;
generate a preference vector associated with at least one accountholder, the preference vector representing historical purchases initiated by the accountholder with a second plurality of merchants;
iteratively calculate a propagated activation vector by mathematically combining the first matrix, the second matrix, the third matrix and the preference vector; and
output a recommendation associated with the at least one accountholder using the propagated activation vector, the recommendation including at least one of a merchant or a product predicted for purchasing by the accountholder.

18. The at least one non-transitory computer-readable storage medium of claim 17, wherein the computer-executable instructions further cause the at least one processor to generate at least one of the first matrix, the second matrix and the third matrix using the one or more AI techniques.

19. The at least one non-transitory computer-readable storage medium of claim 18, wherein the computer-executable instructions further cause the at least one processor to train the one or more AI techniques using the transaction data including merchant data and product data.

20. The at least one non-transitory computer-readable storage medium of claim 17, wherein the computer-executable instructions further cause the at least one processor to interface with a computer application associated with one of the plurality of merchants to (a) determine one or more instant recommendations for in-store items at a store of the merchant and (b) cause the one or more instant recommendations to be displayed, via the computer application, on a user computing device of one of the first or second plurality of users.
